(19) United States
(12) Patent Application Publication
(10) Pub. No.: US 2025/0086084 A1
(43) Pub. Date: Mar. 13, 2025

(54) Technologies For Providing Enhanced Management Of Processing Errors

(71) Applicant: The PNC Financial Services Group, Inc., Pittsburgh, PA (US)

(72) Inventors: David A. Arko, Euclid, OH (US); Paul McAndrew, New Milford, PA (US); Anna Hall-Lloyd, Myrtle Beach, SC (US); Jacqueline M. Roberts, Willoughby, OH (US); Carolyn Gardner, Broadview Heights, OH (US)

(21) Appl. No.: 18/882,271

(22) Filed: Sep. 11, 2024

Related U.S. Application Data
(60) Provisional application No. 63/537,889, filed on Sep. 12, 2023.

(51) Int. Cl. G06F 11/34; G06F 11/07

(52) U.S. Cl. CPC G06F 11/34; G06F 11/0793

(57) ABSTRACT

Technologies for providing enhanced management of processing errors include a compute device. The compute device includes circuitry configured to obtain error data indicative of errors resulting from integration of a component configured to add functionality to a data processing system of an institution. The compute device is also configured to perform statistical analysis on the obtained error data to produce error analytics data and produce a visual representation indicative of the error analytics data to enable efficient remediation of the errors.

### CROSS-REFERENCE TO RELATED APPLICATION

This application claims the benefit, under 35 U.S.C. § 119 (c), of U.S. Provisional Patent Application No. 63/537,889, filed Sep. 12, 2023, the entirety of which is hereby expressly incorporated by reference herein.

### BACKGROUND

Large scale computer systems utilized by institutions with operations spanning multiple industries, customers, and geographic locations may have continually changing components designed to accommodate the changing needs of those industries, customers, and locations. Those components may be developed by teams internal to the institution and/or may be produced by third parties with expertise in designing particular components. In conventional large scale computer systems, errors may occur as a result of imperfect integration of new or modified components into the existing system and the presence and/or magnitude of the errors may be difficult to determine. As a result, in conventional systems, the continual changing of components, though necessary to enable the institution to operate, may cause significant inefficiencies as processing errors are manually identified and rectified.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for providing enhanced error management;

FIG. 2 is a simplified block diagram of at least one embodiment of a compute device of the system of FIG. 1;

FIGS. 3-5 are simplified block diagrams of at least one embodiment of a method for providing enhanced error management that may be performed by the system of FIG. 1;

FIGS. 6-7 are diagrams of visualizations that may be produced by the system of FIG. 1;

FIGS. 8-13 are diagrams of user interfaces that may be produced by the system of FIG. 1;

FIG. 14 is a diagram of at least one embodiment of a data flow between components of the system of FIG. 1; and

FIGS. 15-16 are diagrams of operations that may be performed in connection with the capture, analysis, and management of errors in the system 100 of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

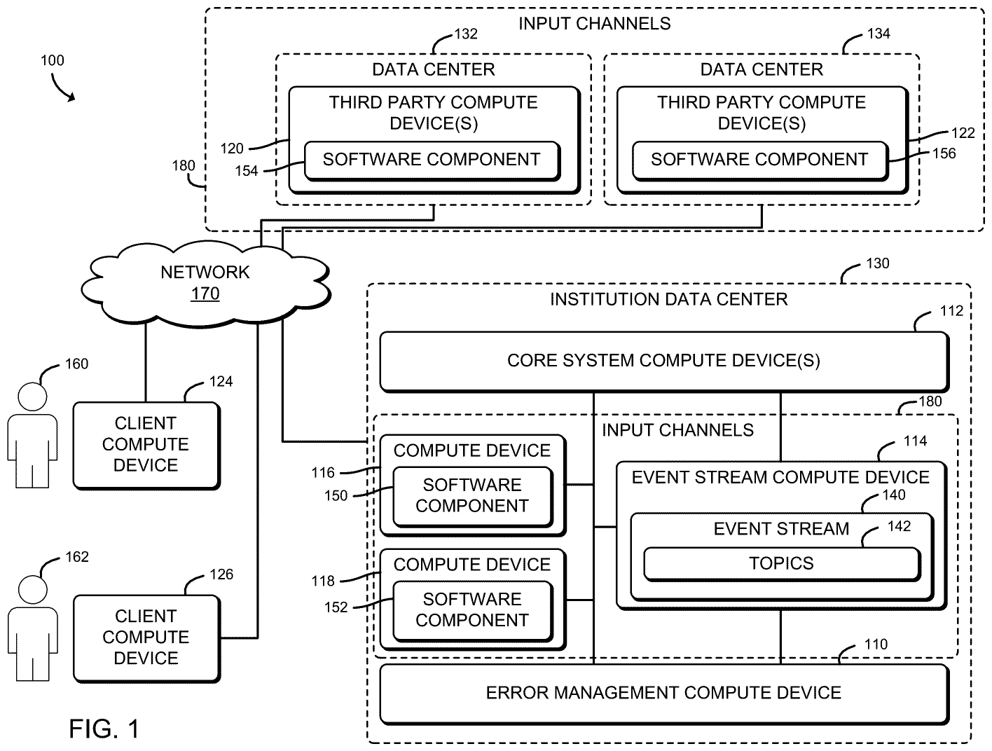

Referring now to FIG. 1, a system 100 for providing enhanced error management includes, in the illustrative embodiment, an error management compute device 110 communicatively connected to an event stream compute device 114 in an institution data center (e.g., a data center housing compute devices operating on behalf of an institution, such as a financial institution). The event stream compute device 114 is communicatively connected to a set of one or more core system compute devices 112 (e.g., systems of record) that perform mission-critical operations on behalf of the institution (e.g., a financial institution). Supplementing the operations of the core system compute device(s) 112, in the illustrative embodiment, are software components 150, 152, 154, 156 (e.g., sets of computer-executable instructions) executed by corresponding compute devices 116, 118, 120, 122 housed in corresponding data centers 130, 132, 134. In the illustrative embodiment, software components 150, 152 are internally developed components (e.g., developed by a team of software engineers internal to the institution) and are executed by compute devices 116, 118 owned and/or operated by the institution, while the software components 154, 156 are developed by third parties (e.g., organizations other than the institution) and are executed by compute devices 120, 122 that are owned and/or operated by those third parties in corresponding data centers 132, 134.

In the batch processing of transactions performed by the various software components, errors may arise due to improper integration between the software components 150, 152, 154, 156 and the core system compute device(s) 112. The errors may include, for example, mismatches between data that is expected by the core system compute device(s) 112 and what is provided by one or more of the software components 150, 152, 154, 156, such as missing data fields, missing records, predecessor versus successor violations, and the like. The software components 150, 152, 154, 156 operate as input channels 180 (e.g., each a source of data for use by the core system compute devices 112 (e.g., system of record)). In some embodiments, one or more input channels 180 may support a publish and subscribe pattern for error management and dissemination. For example, in some embodiments, errors may be published to an event stream 140 in association with topics that can be subscribed to. Other input channel 180 examples may include batch processing as well as real-time updates originating from user interfaces and/or system-to-system integrations. In at least some embodiments, the input channels utilize Application Program Interfaces (API's) for read and/or write operations.

In operation, in at least some embodiments, the error management compute device 110 may subscribe (e.g., through a corresponding application programming interface (API) call) to designated error topic(s) 142 of an event stream 140 (e.g., a data source organized by topics 142 to which error events (e.g., items of data) can be written (e.g., published) and read, through corresponding application programming interface (API) calls) managed by the event stream compute device 114 to collect data regarding the errors. Additionally or alternatively, the error management compute device 110 may obtain data associated with the errors from other sources (e.g., input channels 180). As described in more detail herein, in at least some embodiments, the error management compute device 110 obtains error data for a subset of errors, designated as “rejects”, that have been previously enrolled (e.g., designated) by one or more users for special handling in the error management compute device 110. Because all errors are captured and centralized in the error management compute device 110 by way of different input channels 180, statistical analysis and measurement of errors associated with core system compute devices 112 is facilitated. As a result, the error management compute device 110 is able to generate visual representations (e.g., a web-based user interface rendered in a web browser executed by a client compute device 124, 126), as well as other analytics, to enable personnel 160, 162 responsible for developing and integrating the software components with the core system compute device(s) 112 to easily identify the types of errors that are occurring, how prevalent each type of error is, and trends in the errors over time.

The error management compute device 110 also presents a user interface (e.g., a web-based user interface rendered in a web browser executed by a client compute device 124, 126) that enables the personnel 160, 162 to assign automatically generated tasks among themselves to rectify the errors and access and build upon a knowledge base of solutions to errors. The identification, analysis, and rectification of the errors may occur in a development environment (e.g., operating based on test data) before the software components are used in a production environment (e.g., operating based on real-world data). Additionally or alternatively, the error resolution effort may occur in a production environment. By identifying, performing analytics on, and managing the assignment of remediation tasks for errors that arise in the integration of the software components with the core system compute device(s) 112, the error management compute device 110 enables the system 100 to suit the needs of the institution, without being burdened by integration errors that would otherwise arise and cause inefficiencies (e.g., delayed processing of data awaiting resolution of errors) in a typical system.

While a relatively small number of compute devices 110, 112, 114, 116, 118, 120, 122, 124, 126 are shown for simplicity and clarity, it should be understood that the number of compute devices and corresponding users in practice may range in the tens, hundreds, thousands, or more. Likewise, it should be understood that the compute devices 110, 112, 114, 116, 118, 120, 122 may be housed in a different arrangement and number of data centers than the three data centers 130, 132, 134 shown in FIG. 1. Further, though shown as separate compute devices 110, 112, 114, 116, 118, in some embodiments, the functionality of one or more of the compute devices 110, 112, 114, 116, 118 may be combined into fewer compute devices and/or distributed across more compute devices than those shown in FIG. 1.

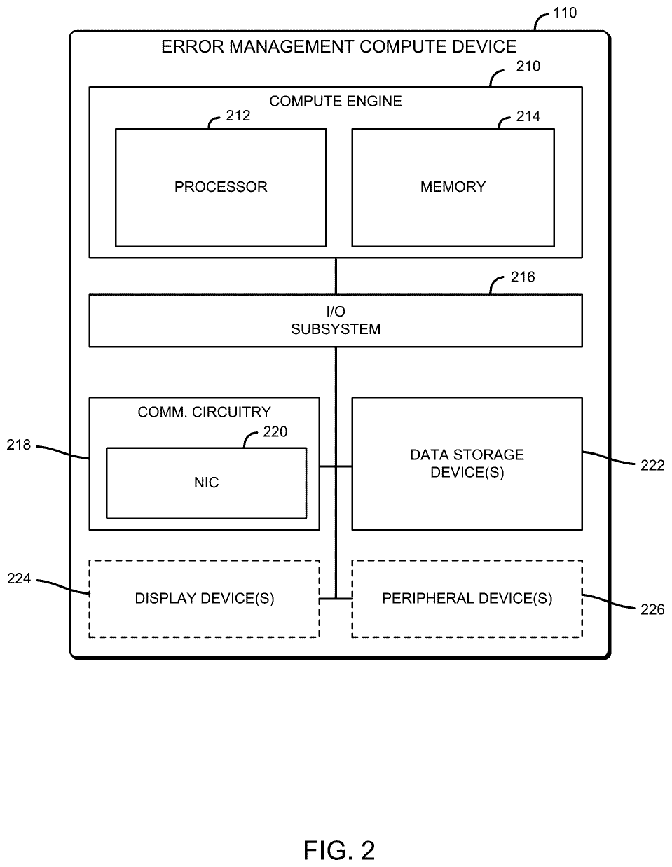

Referring now to FIG. 2, the illustrative error management compute device 110 includes a compute engine 210, an input/output (I/O) subsystem 216, communication circuitry 218, and one or more data storage devices 222. In some embodiments, the error management compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the error management compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as error data indicative of errors generated in the integration of the software components with the core system compute device(s) 112, analytics data produced from performing statistical analysis on the error data, assignments for remediation tasks associated with the errors, and knowledge base data indicative of known solutions to one or more of the errors, applications, libraries, and drivers.

The compute engine 210 is communicatively coupled to other components of the error management compute device 110 via the I/O subsystem 216, which may be embodied as circuitry and/or components to facilitate input/output operations with the compute engine 210 (e.g., with the processor 212 and the main memory 214) and other components of the error management compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the error management compute device 110, into the compute engine 210.

The communication circuitry 218 may be embodied as any communication circuit, device, or collection thereof, capable of enabling communications over a network between the error management compute device 110 and another device (e.g., a compute device 112, 114, 116, 118, 120, 122, 124, 126, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the error management compute device 110 to connect with another compute device (e.g., a compute device 112, 114, 116, 118, 120, 122, 124, 126, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the error management compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the error management compute device 110 are housed in a single unit. However, in other embodiments, the components may be in separate housings, in separate racks of a data center, and/or spread across multiple data centers or other facilities. The compute devices 112, 114, 116, 118, 120, 122, 124 may have components similar to those described in FIG. 2 with reference to the error management compute device 110. The description of those components of the error management compute device 110 is equally applicable to the description of components of the compute devices 112, 114, 116, 118, 120, 122, 124. Further, it should be appreciated that any of the devices 110, 112, 114, 116, 118, 120, 122, 124 may include other components, sub-components, and devices commonly found in a computing device, which are not discussed above in reference to the error management compute device 110 and not discussed herein for clarity of the description.

In the illustrative embodiment, the compute devices 110, 112, 114, 116, 118, 120, 122, 124 are in communication via a network 170, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

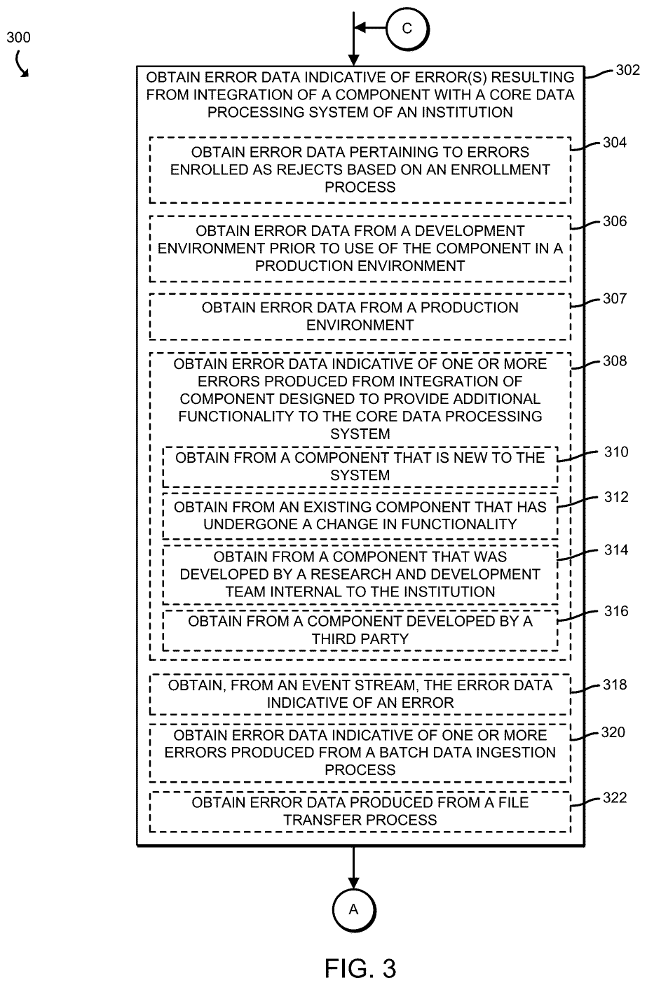

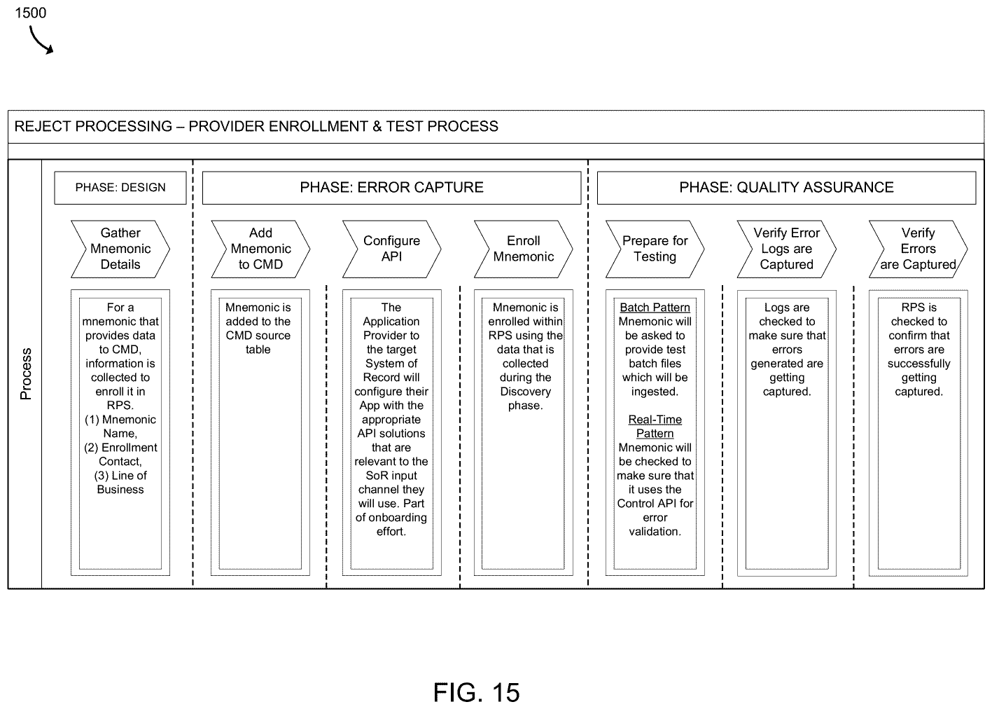

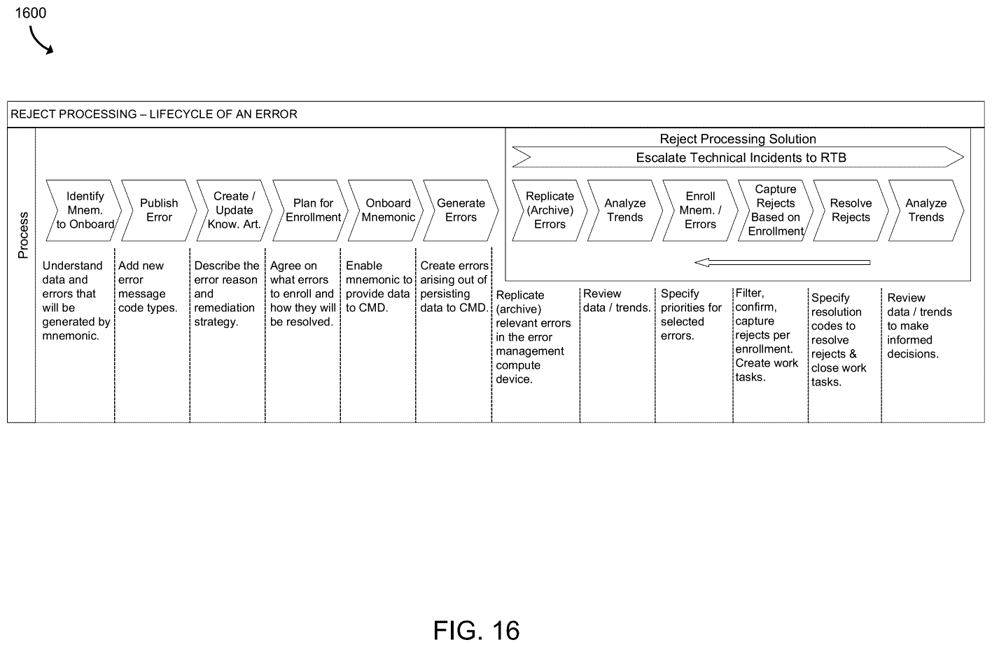

Referring now to FIG. 3, the system 100, and more specifically, the error management compute device 110, in the illustrative embodiment, may perform a method 300 for efficiently managing errors (e.g., that may arise during the integration of a software component 150, 152, 154, 156) with the core system compute device(s) 112 of an institution. In the illustrative embodiment, the error management compute device 110 continually and repeatedly executes the operations in the method 300, such that an operation presented herein as an initial operation (e.g., a data collection operation) may be executed after a subsequently presented operation (e.g., a data visualization method) in a later iteration of the method 300. Further, the operations may be performed in a different order in other embodiments. In addition to the operations executed in the method 300, operations performed by an organization in connection with the use of the error management system 110 are represented in diagrams 1500, 1600 of FIGS. 15 and 16. In these figures, “RPS” stands for “reject processing solution”, a reference to an embodiment of the error management compute device 110. Further, in the figures, “CMD” stands for “customer master data” which is a core system compute device 112 (e.g., system of record). In block 302, the error management compute device 110 obtains error data, which may be embodied as any data (e.g., textual, binary, etc.) indicative of one or more errors resulting from integration of a component (e.g., a software component 150, 152, 154, 156) with a core data processing system (e.g., systems of record, such as the core system compute device(s) 112) of an institution (e.g., a financial institution such as a bank).

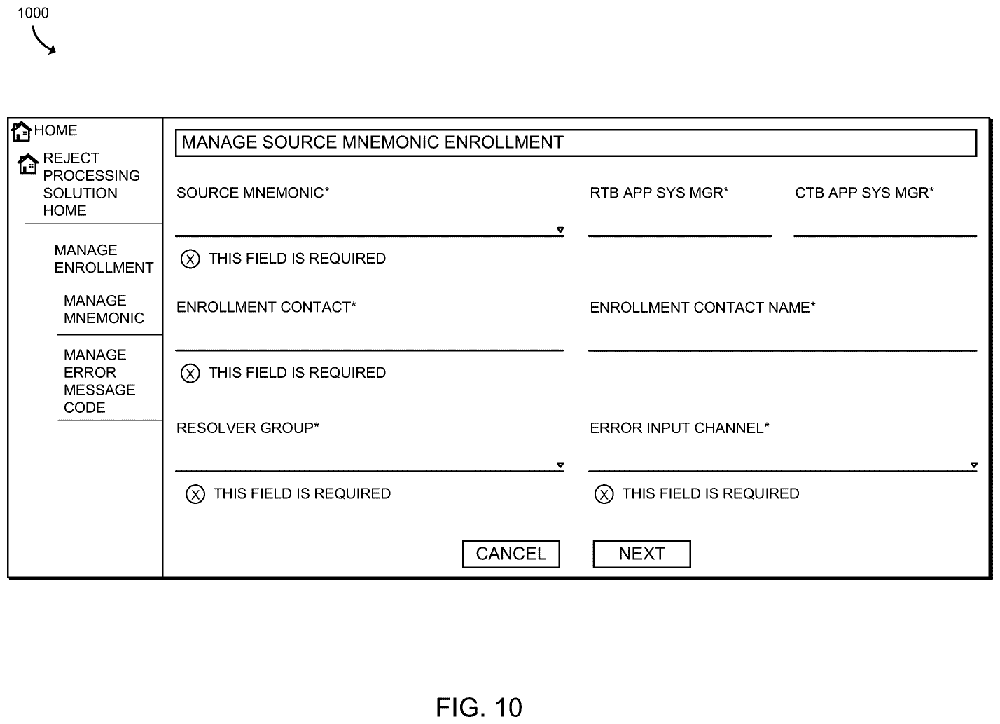

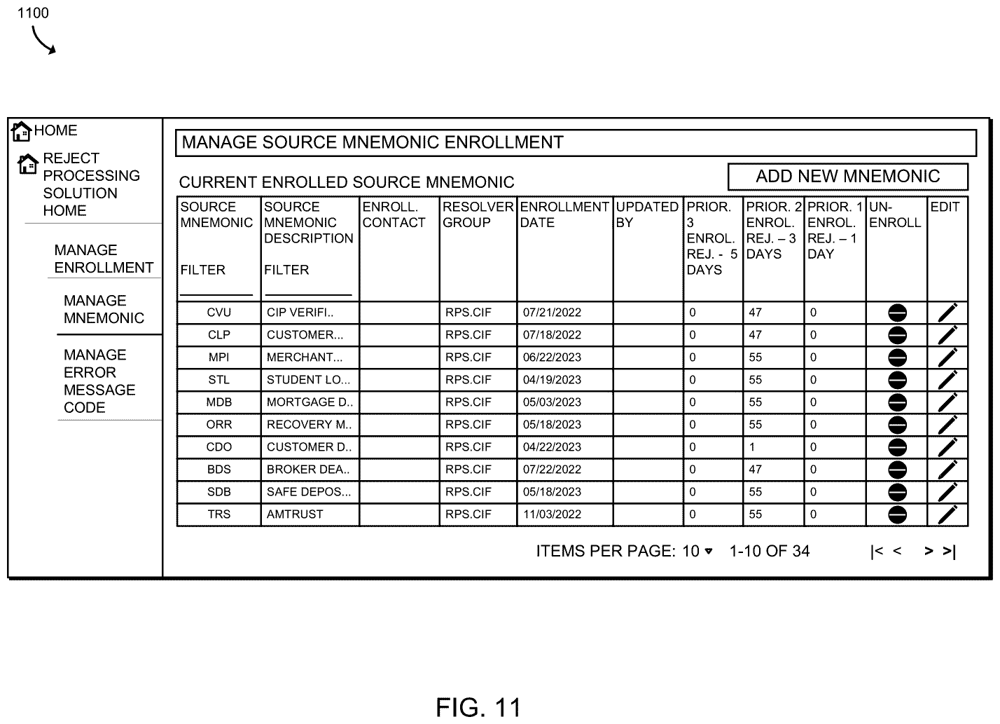

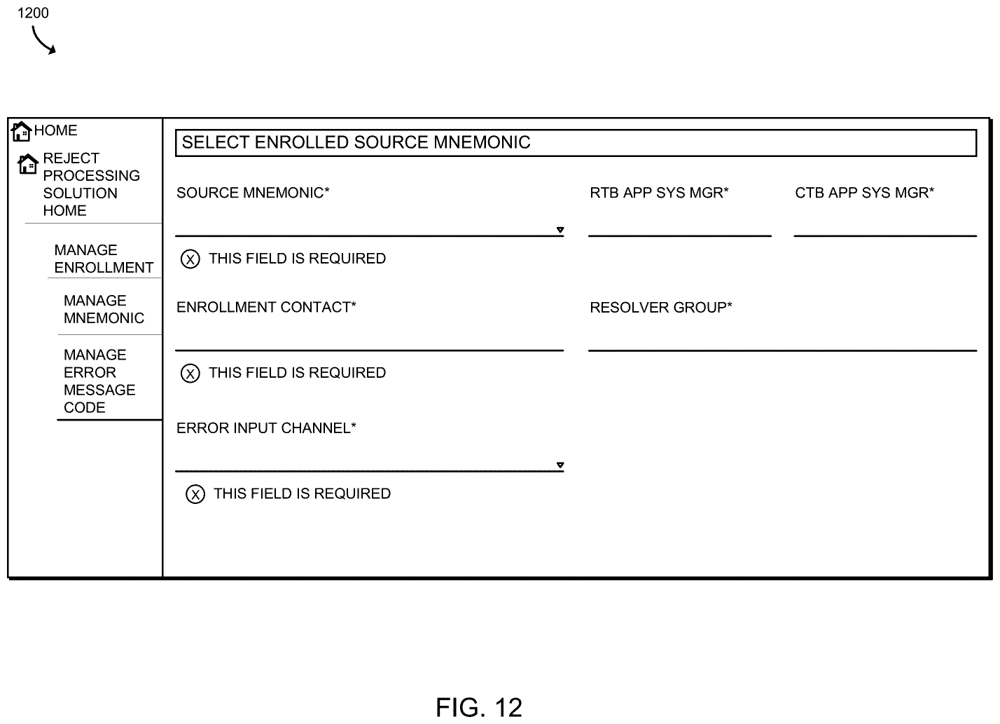

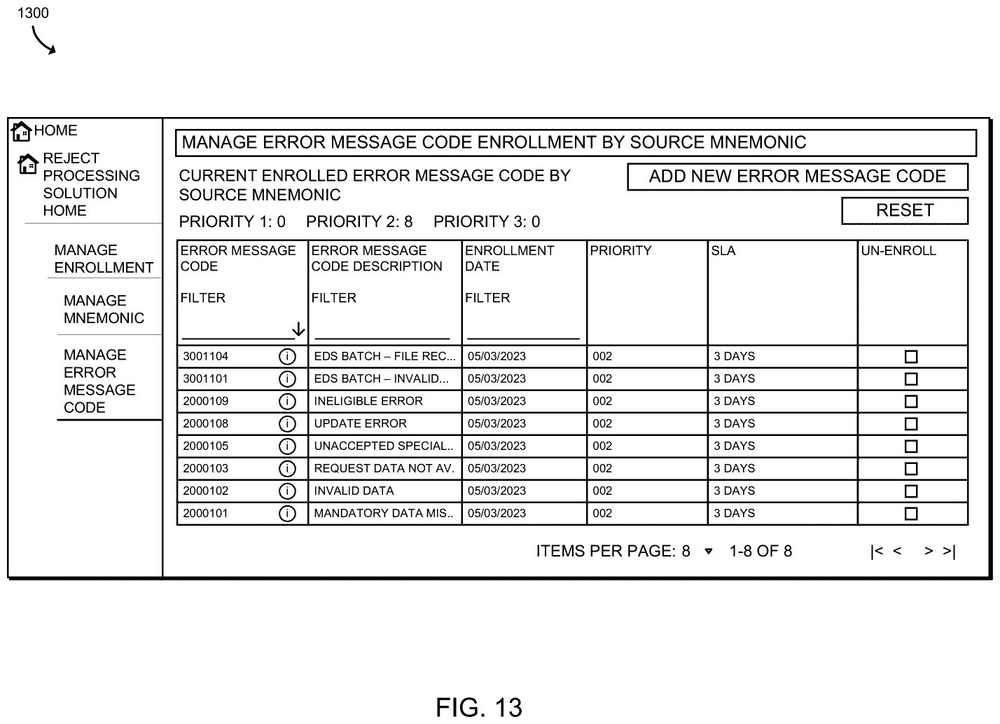

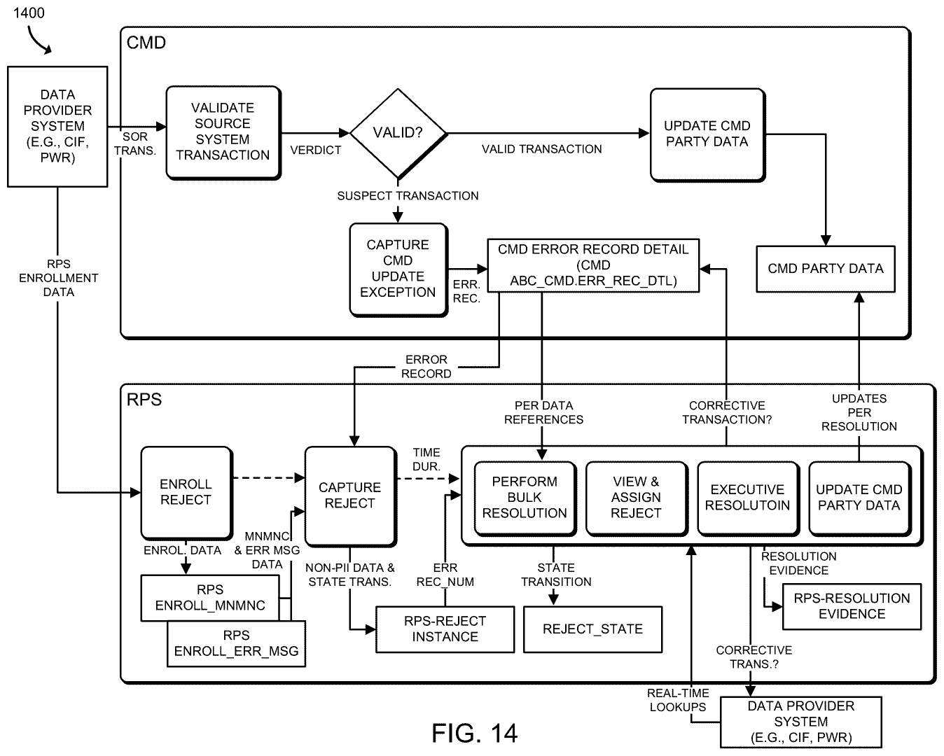

In at least some embodiments, in obtaining error data, the error management compute device 110 obtains error data pertaining to errors that have been enrolled as “rejects” based on an enrollment process, as indicated in block 304. Errors relevant to the error management compute device 110, in at least some embodiments, originate in the input channels 180 of FIG. 1. A capture operation supports capture of certain error data originating from the input channels 180. In some embodiments, the capture process is implemented using pull or subscribe patterns. An objective of the capture process is to archive all business error instances originating from a respective input channel 180. A comprehensive archive of all system of record based errors facilitates audit, reporting, and analytics. Further, a classification of errors as rejects or not may be performed. Error classification may be dependent on an integration to retrieve and apply error enrollment data. In at least some embodiments, only errors classified as rejects are subject to enhanced error management and task based resolution in a downstream resolve reject operation. The enrollment function exists to inform and educate. That is, various analytical class reports may be made available to application stakeholders to expose the error management problem domain. As described herein, a knowledge base, in at least some embodiments, is available to describe system of record error codes as well as relevant information to facilitate error resolution. Enrolling a mnemonic allows a specific application solution to participate in the enhanced error management. In the enrollment process, a system administrator may solicit certain information about an application to accomplish this goal. Enrolling an error allows an application owner or user to identify (e.g., subscribe to) one or more error descriptions or codes that they want to enroll for managed task based resolution efforts. Certain data attributes are solicited for each enrolled error. This data drives policy based enhanced error management for an application. The attributes may include priority level, service level agreement duration, and resolver group. The process facilitates repeatable capture and resolution processing efforts if and when an enrolled error is evidenced in an application's execution. Embodiments of user interfaces 1000, 1100, 1200, 1300 for managing the enrollment of mnemonics (e.g., applications that provide data to the customer data management system), management of enrolled mnemonics inclusive of contacts/groups who will be responsible to resolve errors (e.g., rejects) for their assigned mnemonic(s), and enrollment of errors as rejects are shown in FIGS. 10-13. In the figures, the term “mnemonic” refers to a three character code identifying a software component (e.g., a software component 150, 152, 154, 156) charged with updating a core system compute device 112. That is, the software component referenced by the mnemonic is a provider. Additionally, in the figures, the term “RTB” stands for “run the bank”, which is a team charged with day-to-day operational support of the mnemonic/software component/provider. The term “CTB” in the figures refers to “change the bank”, which is a team that is charged with ongoing development of the mnemonic/software component/provider. An embodiment of the system 100 for supporting the enrollment operations, tracking errors enrolled as rejects, and reporting trends and statistical data regarding the rejects is illustrated in the diagram 1400 of FIG. 14. The scenario depicted in FIG. 14 is a pull scenario, in which the RPS (e.g., error management compute device 110) pulls error records from one or more input channels 180 by way of scheduled batch execution. For the remainder of the description of the method 300, for embodiments in which enrollment of selected errors as rejects is supported and performed, references to errors and error data pertain to errors that have been enrolled as rejects.

In some embodiments, the error management compute device 110 obtains the error data from a development environment prior to use of the component (e.g., software component 150, 152, 154, 156) in a production environment, as indicated in block 306. That is, the error management compute device 110 may obtain the error data based on operations executed on test data rather than live, real-world data from transactions with customers. Additionally or alternatively, the error management compute device 110 may obtain the error data from a production environment (e.g., error data produced based on operations performed on real-world data), as indicated in block 307.

As indicated in block 308, the error management compute device 110 may obtain error data indicative of one or more errors produced from the integration of a component designed to provide additional functionality to the core data processing system (e.g., the software components 150, 152, 154, 156 provide functionality that the core system compute device(s) 112 do not inherently have), such as processing transactions associated with new types of parties or entities, processing transactions associated with new financial products or currencies, etc. In doing so, the error management compute device 110 may obtain the error data produced from integration of a component that is new to the system or from integration of an existing component that has undergone a change in functionality, as indicated in blocks 310 and 312 respectively. As indicated in block 314, the error management compute device 110 may obtain error data produced from integration of a component that was developed by a research and development team internal to the institution (e.g., software engineers employed by the financial institution), such as the software components 150, 152 executed within the institution data center 130 of FIG. 1. Additionally or alternatively, as indicated in block 316, the error management compute device 110 may obtain error data produced from integration of a component developed by a third party, such as either or both of the software components 154, 156 executed by third party compute devices 120, 122 in the system 100 shown in FIG. 1.

In the illustrative embodiment, and as indicated in block 318, the error management compute device 110 may obtain the error data from an event stream 140 (e.g., a data source organized by topics 142 to which events (e.g., items of data) can be written (e.g., published) and read, through corresponding application programming interface (API) calls). The event stream, in the illustrative embodiment, is managed by the event stream compute device 114, as described with reference to FIG. 1. In at least some embodiments, as indicated in block 320, the error management compute device 110 obtains error data that is indicative of one or more errors that were produced from a batch data ingestion process (e.g., reading and assimilation of data from a defined time period such as the past 24 hours, rather than in real time) during the integration of the component(s) 150, 152, 154, 156. As indicated in block 322, in some embodiments, the error management compute device 110 may obtain error data produced from a file transfer process (e.g., a file transfer from a software component 150, 152, 154, 156 to the core system compute device(s) 112).

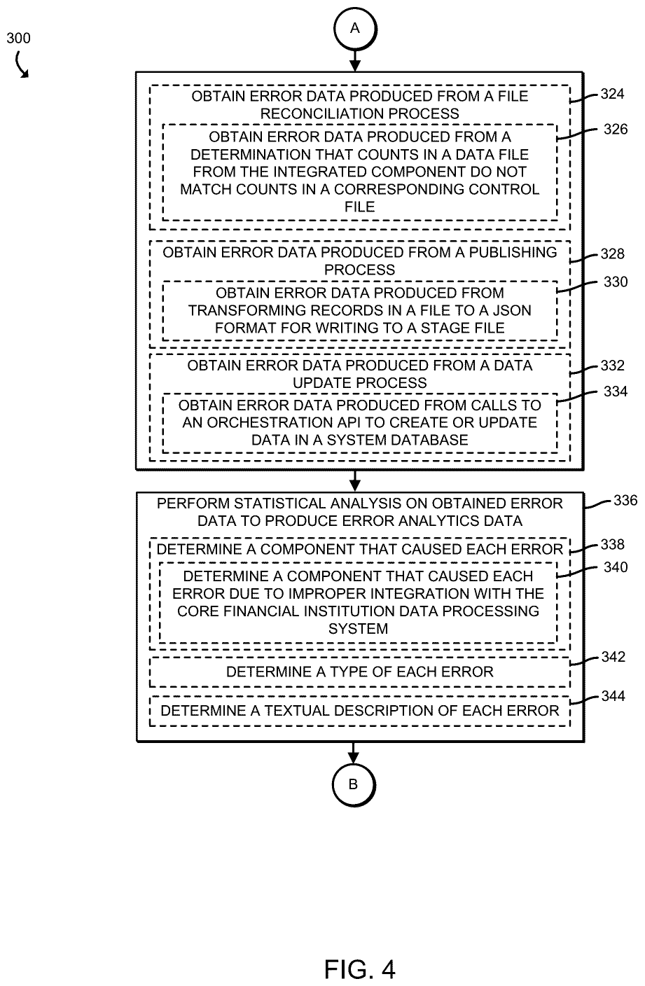

Referring now to FIG. 4, in block 324, the error management compute device 110 may obtain error data produced from a file reconciliation process. In doing so, and as indicated in block 326, the error management compute device 110 may obtain error data that was produced from a determination that counts in a data file from the integrated component (e.g., software component 150, 152, 154, 156) does not match the counts in a corresponding control file. That is, the error management compute device 110 may obtain error data indicating that a control file (e.g., in a memory or data storage of the core system compute device(s) 112) indicated that a file from a particular software component would have a specified number of records or data items and that the file that was actually received from the software component had a different number of records or data items. Additionally or alternatively, the error management compute device 110 may obtain error data produced from a publishing process associated with the integration of a component (e.g., a software component 150, 152, 154, 156) with the core system compute device(s) 112, as indicated in block 328.

In doing so, and as indicated in block 330, the error management compute device 110 may obtain error data that was produced from transforming record in a file (e.g., from a software component 150, 152, 154, 156) to another format, such as an object notation format (e.g., JavaScript Object Notation). In some embodiments, a reformatting of the data (e.g., from the original format in the file to the object notation) may be necessary to prepare the data for use in another file type used by the core system compute device(s) 112, such as a stage file. Additionally or alternatively, the error management compute device 110 may obtain error data that was produced from a data update process (e.g., adding or updating data in a data set), as indicated in block 332. In doing so, and as represented in block 334, the error management compute device 110 may obtain error data that was produced from one or more calls to an application programming interface (e.g., an orchestration API) to create or update data in a system database (e.g., a relational database).

The method 300 continues in block 336, in which the error management compute device 110 performs statistical analysis on the obtained error data to produce error analytics data (e.g., any data representing a result of performing an analysis on the error data that was obtained in block 304). In performing the analysis, the error management compute device 110 may combine the data obtained in block 304 with other error data previously obtained by the error management compute device 110 (e.g., as a cumulative set of error data). While performing the analysis and as indicated in block 338, the error management compute device 110 may determine the component (e.g., software component 150, 152, 154, 156) that caused each error, such as by reading an identifier in the error data that uniquely identifies the corresponding software component 150, 152, 154, 156. In the illustrative embodiment, the error management compute device determines a component (e.g., a software component 150, 152, 154, 156) that caused each error due to improper integration with the core institution data processing system (e.g., the core system compute device(s) 112), as indicated in block 340. That is, in the illustrative embodiment, the errors are due to complications in the integration of a given component 150, 152, 154, 156 with the core system compute devices 112, due to data formatting issues, missing data, or related issues, as discussed above. In block 342, the error management compute device 110 determines a type of each error (e.g., from a type identifier, an error code, or related indicia encoded in the obtained error data). As indicated in block 344, the error management compute device 110 may determine a textual description (e.g., a human readable description) of each error. For example, the error management compute device 110 may reference a data set (e.g., in the memory 214 or data storage 222) that associates error codes with human-readable textual descriptions to determine the textual description corresponding to a given error code.

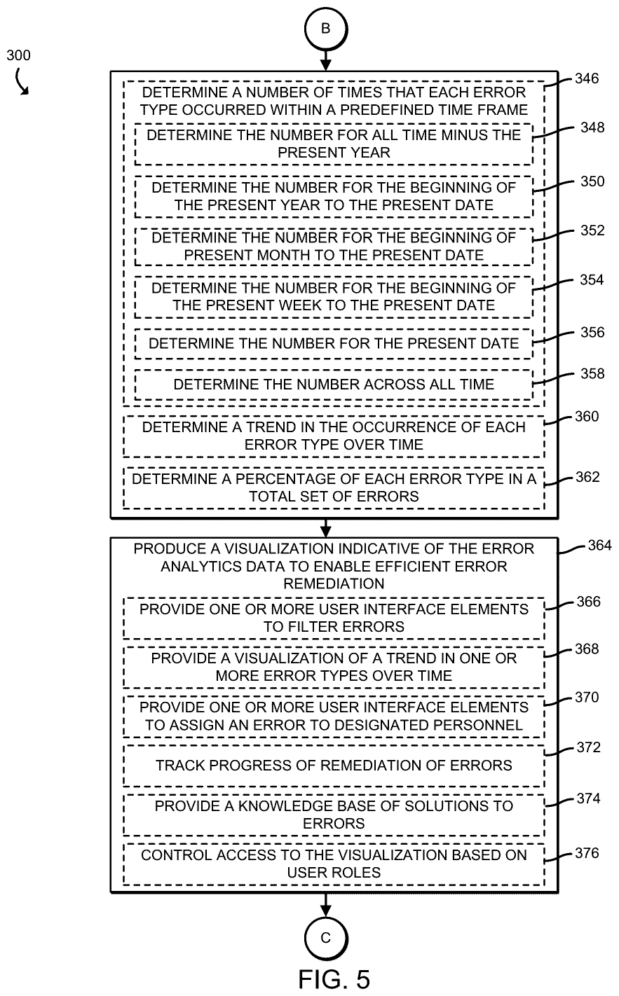

Referring now to FIG. 5, the error management compute device 110 may determine a number of times that each error type occurred within a predefined time frame, as indicated in block 346. In doing so, the error management compute device 110 may determine the number of times each error type occurred for all time minus the present year, as indicated in block 348. Additionally or alternatively, the error management compute device 110 may determine the number of times each error type occurred from the beginning of the present year to the present date, as indicated in block 350. The error management compute device 110 may also determine the number of times each error type occurred from the beginning of the present month to the present date or from the beginning of the present week to the present date, as indicated in blocks 352 and 354 respectively. The error management compute device 110 may also determine the number of times each error type occurred for the present date, as indicated in block 356. In block 358, the error management compute device 110 may determine the number of times each error type occurred across all time (e.g., from the earliest date represented in the error date to the present date). As indicated in block 360, the error management compute device 110 may determine a trend (e.g., increasing, decreasing, constant rate, etc.) in the occurrence of errors of each type over time. Additionally, the error management compute device 110 may determine a percentage or proportion of each error type in a total set of errors (e.g., all errors represented in the error data), as indicated in block 362. As such, the error management compute device 110 may enable ready identification of the most prevalent types of errors.

Subsequently, and as indicated in block 364, the error management compute device 110 produces a visualization (e.g., a visual representation) indicative of the error analytics data, to enable efficient error remediation. The visualization may be embodied as a set of code and graphics data (e.g., hypertext markup language, JavaScript, image files, etc.) that may be rendered by a compute device (e.g., a client compute device 124, 126, executing a web browser or other rendering engine). As indicated in block 366, the error management compute device 110 may provide one or more user interface elements to enable a user 160, 162 to filter errors (e.g., by error type). As indicated in block 368, the error management compute device 110 may provide a visualization (e.g., a plot) of a trend in one or more error types over time. The error management compute device 110 may provide one or more user interface elements to enable a user to assign an error to designated personnel, as indicated in block 370. As indicated in block 372, the error management compute device 110 may track the progress of remediation of errors (e.g., determine whether an error has been remediated or not, whether the error has been reassigned to another person for remediation, etc.). The error management compute device 110 may provide a knowledge base of solutions to errors to enable a person to easily remediate an error rather than experimenting to determine a solution, as indicated in block 374. As indicated in block 376, the error management compute device 110, in the illustrative embodiment, controls access to the visualization based on user roles (e.g., selectively enabling or disabling access to the visualization and features thereof based on access rights assigned to user roles). While the operations of the method 300 are shown in a particular order in the diagrams of FIGS. 3-5 for simplicity and clarity, it should be understood that, in some embodiments, the operations may be performed in other orders and/or concurrently.

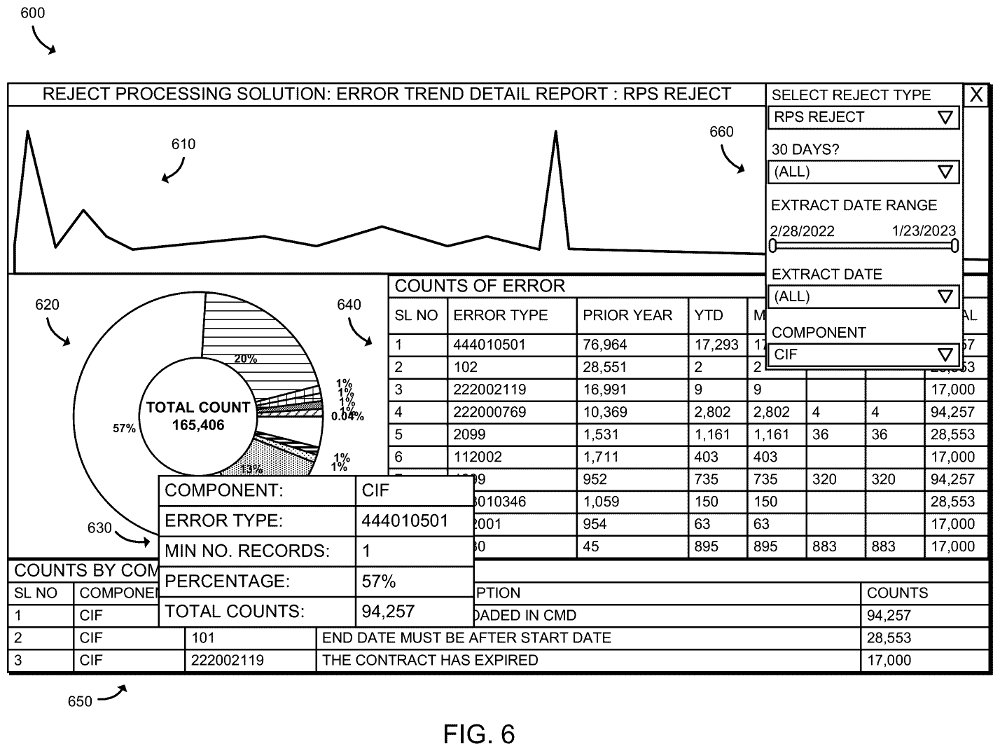

Referring now to FIG. 6, a visualization 600 produced by the error management compute device 110, in the illustrative embodiment, may be presented by a compute device (e.g., a client compute device 124, 126) using graphics data (e.g., image files such as Portable Network Graphics (PNG) files, Joint Photographic Experts Group (jpg) files, Graphics Interchange Format (GIF) files, and the like), and executable code such as JavaScript, sent from the error management compute device 110 through the network 170. The illustrative visualization 600 includes a plot 610 of the occurrences of errors over time, a pie chart 620 representing the portion of each error type in a total set of errors captured by the error management compute device 110, and a contextual window 630 that appears in response to selection of a portion of the pie chart 620 to indicate the component (e.g., software component) responsible for the errors associated with the selected portion of the pie chart 620, an error type code, the percentage of the total errors represented by the selected portion of the pie chart 620, and the total number of errors (e.g., the selected portion of the pie chart and all other portions of the pie chart combined).

The visualization 600 also includes a list 640 of counts of errors, organized by error type and a list 650 of counts of errors, organized by the component responsible for the error(s). Additionally, the visualization 600 includes a panel 660 with user interface elements that enable the user to filter the underlying data (e.g., analytics data) to a specific error type (e.g., reject type), time frame, and/or component responsible for causing the error(s). By providing process feedback, such as the visualization 600, other report analytics, and the like, the error management compute device 110 enables a user 160 to quickly ascertain which error types are occurring the most within the system 100 and which component (e.g., software component 150, 152, 154, 156) is responsible for causing those errors. A user may then may make more informed decisions on how to most effectively and efficiently remediate integration errors that are occurring in the system 100, such as by targeting the error types and components responsible for the highest frequency of errors or prioritizing the remediation of errors associated with a component that is slated to enter production before certain other components.

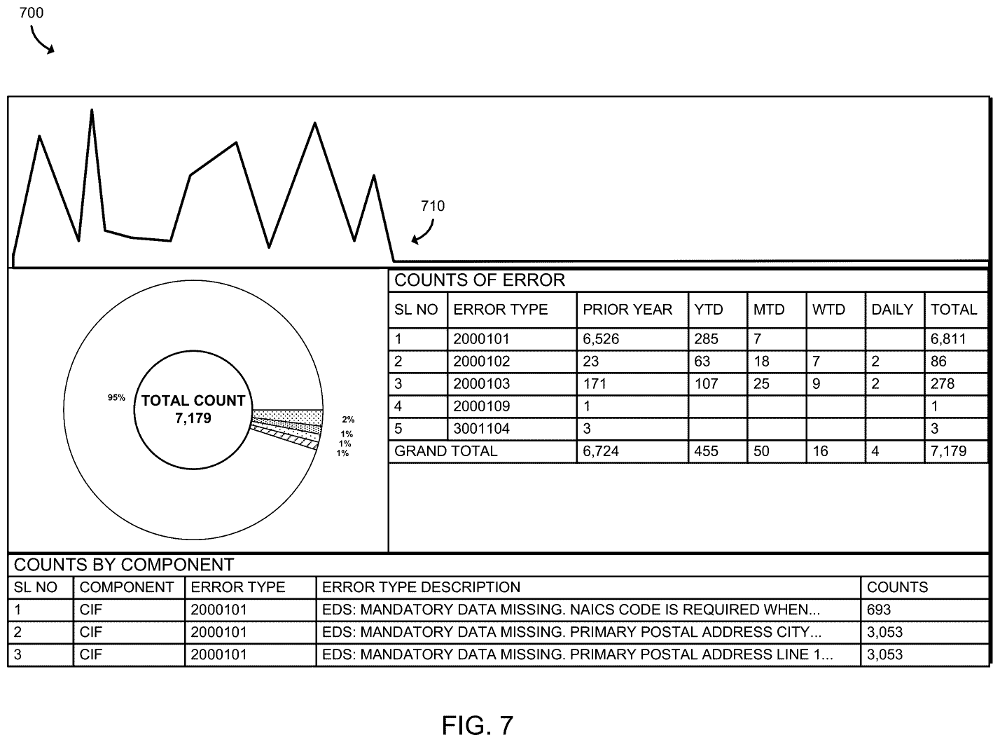

Referring now to FIG. 7, an example embodiment of a visualization 700 produced by the error management compute device 110 illustrates a sharp reduction 710 in the occurrence of error type 2000101, which was produced by a particular software component (“CIF”) and pertained to missing data. In the figures, the term “EDS” refers to an API solution for interfacing with customer master data (CMD) and may be employed in one or more input channels 180. As shown in the visualization 700, in the prior year, 6,526 instances of the error type were detected. Leading up to the present month, 285 instances of the error type were recorded. In the present month, only seven instance were recorded and in the present week, no instances were detected. By producing analytics data based on the error data and presenting the analytics data in a visualization (e.g., the visualization 600), the error management compute device 110 enabled immediate identification of error types with the highest occurrence rate in the system 100 and efficient remediation of the underlying problem (e.g., missing data fields) in the integration of the CIF software component with the core system compute devices 112.

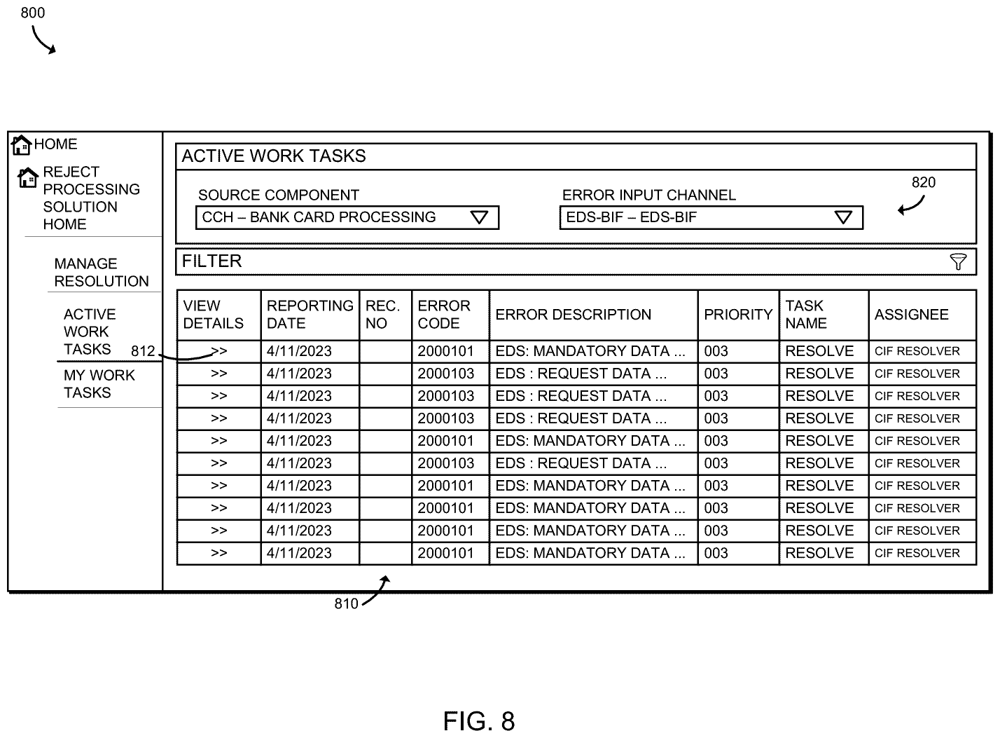

Referring now to FIG. 8, a user interface 800 that may be produced by the error management compute device 110 includes, in the illustrative embodiment, a list 810 of active work tasks that have been assigned to software engineers to remediate errors detected in the system 100 (e.g., errors represented in the visualizations 600, 700). In the user interface, the term “EDS-BIF” refers to a batch-ingestion framework, which may be an embodiment of an input channel 180 for updating a core system compute device 112 such as CMD (customer master data) and may utilize EDS API solutions appropriate for batch. The list 810 includes, for each task, the reporting date, the error code (e.g., error type), a textual description of the error, a priority assigned to the remediation task, the name of the task, and the assignee (person or role of person assigned to perform the remediation task). The user interface 800 also includes a set 820 of user interface elements that enable the user (e.g., the user 160) to filter the errors in the list 810 by selected criteria including the component (e.g., software component 150, 152, 154, 156) responsible for causing the error and/or an error input channel (e.g., data ingestion channel in which the error occurred). For each item in the list 810, a user interface element 812, if selected, causes a corresponding work task details screen to be presented.

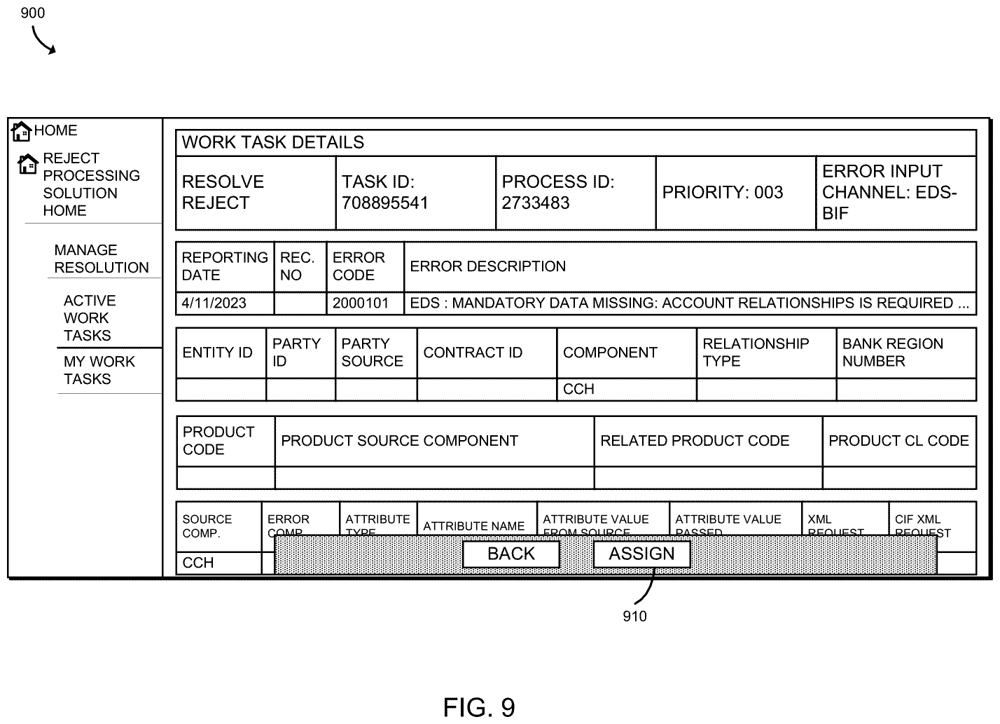

Referring now to FIG. 9, the error management compute device 110 may produce a user interface 900 to present details of a selected work task. The illustrative user interface 900 may be produced in response to a determination that the user interface element 812 of the user interface 800 was selected (e.g., clicked on). The user interface 900 includes a user interface element 910 (e.g., a button) that, in response to being selected, enables the user (e.g., the user 160) to assign the present work task to a person or role. The error management compute device 110 controls access to the visualizations 600, 700 and user interfaces 800, 900, based on user roles. Accordingly, when a particular user having a particular identity or role successfully authenticates and uses the error management compute device 110 (e.g., via their client compute device 124, 126) to view information about errors detected in the system 100 and remediation tasks, any remediation tasks assigned to that user (e.g., via the button 912) will be presented to the user in a corresponding list (e.g., in a “my work tasks” user interface). Accordingly, in addition to compiling error data and presenting a readily-understood visualization of the errors occurring in the system 100, the error management compute device 110 enhances the coordination of remediation of those errors among a team of software engineers. As such, compared to conventional systems in which integration of new or modified components may cause lingering errors that slow down processing operations within the system, by efficiently detecting, analyzing, and managing the remediation of component integration errors, the error management compute device 110 vastly increases the speed with which new processing capabilities (e.g., via the software components 150, 152, 154, 156) can be added to the system 100.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### Examples

Illustrative examples of the technologies disclosed herein are provided below. An embodiment of the technologies may include any one or more, and any combination of, the examples described below.

Example 1 includes a compute device comprising circuitry configured to obtain error data indicative of errors resulting from integration of a component configured to add functionality to a data processing system of an institution; perform statistical analysis on the obtained error data to produce error analytics data; and produce a visual representation indicative of the error analytics data to enable efficient remediation of the errors.

Example 2 includes the subject matter of Example 1, and wherein to obtain the error data comprises to obtain error data pertaining to a subset of errors enrolled as rejects in an enrollment process.

Example 3 includes the subject matter of any of Examples 1 and 2, and wherein to obtain the error data comprises to obtain the error data from an event stream.

Example 4 includes the subject matter of any of Examples 1-3, and wherein to obtain the error data comprises to obtain error data indicative of one or more errors produced from a component that is new to the data processing system or that that has undergone a change in functionality.

Example 5 includes the subject matter of any of Examples 1-4, and wherein to obtain the error data comprises to obtain error data indicative of one or more errors produced from a component developed by a party other than an institution operating the data processing system.

Example 6 includes the subject matter of any of Examples 1-5, and wherein to obtain the error data comprises to obtain error data produced from a batch data ingestion process.

Example 7 includes the subject matter of any of Examples 1-6, and wherein to obtain the error data comprises to obtain error data produced from a file transfer process between the component and the data processing system.

Example 8 includes the subject matter of any of Examples 1-7, and wherein to obtain the error data comprises to obtain error data produced from a file reconciliation process associated with the integration.

Example 9 includes the subject matter of any of Examples 1-8, and wherein to obtain the error data comprises to obtain error data produced from a determination that a count of data items in a data file from the component does not match a count of records in a corresponding control file.

Example 10 includes the subject matter of any of Examples 1-9, and wherein to obtain the error data comprises to obtain error data produced from a publishing process associated with the integration.

Example 11 includes the subject matter of any of Examples 1-10, and wherein to obtain the error data comprises to obtain error data produced from transforming records in a file associated with the component to an object notation format.

Example 12 includes the subject matter of any of Examples 1-11, and wherein to obtain the error data comprises to obtain error data produced from a data update process associated with the integration.

Example 13 includes the subject matter of any of Examples 1-12, and wherein to obtain the error data comprises to obtain error data produced from one or more calls to an application programming interface associated with the data processing system to create or update data in a system database.

Example 14 includes the subject matter of any of Examples 1-13, and wherein to perform statistical analysis on the obtained error data comprises to determine the component that caused each error.

Example 15 includes the subject matter of any of Examples 1-14, and wherein to perform statistical analysis on the obtained error data comprises to determine a textual description of each error.

Example 16 includes the subject matter of any of Examples 1-15, and wherein to perform statistical analysis on the obtained error data comprises to determine a number of times that each type of error occurred within a predefined time frame.

Example 17 includes the subject matter of any of Examples 1-16, and wherein to determine the number of times that each type of error occurred within a predefined time frame comprises to determine the number for all time minus the present year, determine the number for the beginning of the present year to the present date, determine the number for the beginning of the present month to the present date, determine the number for the beginning of the present week to the present date, determine the number for the present date, or determine the number across all time.

Example 18 includes the subject matter of any of Examples 1-17, and wherein to perform statistical analysis on the obtained error data comprises to determine a trend in occurrences of each error over time.

Example 19 includes the subject matter of any of Examples 1-18, and wherein to perform statistical analysis on the obtained error data comprises to determine a percentage of each type of error in a total set of errors.

Example 20 includes the subject matter of any of Examples 1-19, and wherein to produce a visualization indicative of the error analytics data comprises to provide one or more user interface elements to filter the errors.

Example 21 includes the subject matter of any of Examples 1-20, and wherein to produce a visualization indicative of the error analytics data comprises to provide a visualization of a trend in one or more error types over time.

Example 22 includes the subject matter of any of Examples 1-21, and wherein to produce a visualization indicative of the error analytics data comprises to provide one or more user interface elements to assign an error to designated personnel for remediation.

Example 23 includes the subject matter of any of Examples 1-22, and wherein to produce a visualization indicative of the error analytics data comprises to track a progress of remediation of errors.

Example 24 includes the subject matter of any of Examples 1-23, and wherein to provide a visualization indicative of the error analytics comprises to provide a knowledge base of solutions to errors.

Example 25 includes the subject matter of any of Examples 1-24, and wherein to provide a visualization indicative of the error analytics comprises to control access to the visualization based on user roles.

Example 26 includes a method comprising obtaining, by a compute device, error data indicative of errors resulting from integration of a component configured to add functionality to a data processing system of an institution; performing, by the compute device, statistical analysis on the obtained error data to produce error analytics data; and producing, by the compute device, a visual representation indicative of the error analytics data to enable efficient remediation of the errors.

Example 27 includes the subject matter of Example 26, and wherein obtaining the error data comprises obtaining error data pertaining to a subset of errors enrolled as rejects in an enrollment process.

Example 28 includes the subject matter of any of Examples 26 and 27, and wherein obtaining the error data comprises obtaining the error data from an event stream.

Example 29 includes the subject matter of any of Examples 26-28, and wherein obtaining the error data comprises obtaining error data indicative of one or more errors produced from a component that is new to the data processing system or that has undergone a change in functionality.

Example 30 includes the subject matter of any of Examples 26-29, and wherein obtaining the error data comprises obtaining error data indicative of one or more errors produced from a component developed by a party other than an institution operating the data processing system.

Example 31 includes the subject matter of any of Examples 26-30, and wherein obtaining the error data comprises obtaining error data produced from a batch data ingestion process.

Example 32 includes the subject matter of any of Examples 26-31, and wherein obtaining the error data comprises obtaining error data produced from a file transfer process between the component and the data processing system.

Example 33 includes the subject matter of any of Examples 26-32, and wherein obtaining the error data comprises obtaining error data produced from a file reconciliation process associated with the integration.

Example 34 includes the subject matter of any of Examples 26-33, and wherein obtaining the error data comprises obtaining error data produced from a determination that a count of data items in a data file from the component does not match a count of records in a corresponding control file.

Example 35 includes the subject matter of any of Examples 26-34, and wherein obtaining the error data comprises obtaining error data produced from a publishing process associated with the integration.

Example 36 includes the subject matter of any of Examples 26-35, and wherein obtaining the error data comprises obtaining error data produced from transforming records in a file associated with the component to an object notation format.

Example 37 includes the subject matter of any of Examples 26-36, and wherein obtaining the error data comprises obtaining error data produced from a data update process associated with the integration.

Example 38 includes the subject matter of any of Examples 26-37, and wherein obtaining the error data comprises obtaining error data produced from one or more calls to an application programming interface associated with the data processing system to create or update data in a system database.

Example 39 includes the subject matter of any of Examples 26-38, and wherein performing statistical analysis on the obtained error data comprises determining the component that caused each error.

Example 40 includes the subject matter of any of Examples 26-39, and wherein performing statistical analysis on the obtained error data comprises determining a textual description of each error.

Example 41 includes the subject matter of any of Examples 26-40, and wherein performing statistical analysis on the obtained error data comprises determining a number of times that each type of error occurred within a predefined time frame.

Example 42 includes the subject matter of any of Examples 26-41, and wherein determining the number of times that each type of error occurred within a predefined time frame comprises determining the number for all time minus the present year, determining the number for the beginning of the present year to the present date, determining the number for the beginning of the present month to the present date, determining the number for the beginning of the present week to the present date, determining the number for the present date, or determining the number across all time.

Example 43 includes the subject matter of any of Examples 26-42, and wherein performing statistical analysis on the obtained error data comprises determining a trend in occurrences of each error over time.

Example 44 includes the subject matter of any of Examples 26-43, and wherein performing statistical analysis on the obtained error data comprises determining a percentage of each type of error in a total set of errors.

Example 45 includes the subject matter of any of Examples 26-44, and wherein producing a visualization indicative of the error analytics data comprises providing one or more user interface elements to filter the errors.

Example 46 includes the subject matter of any of Examples 26-45, and wherein producing a visualization indicative of the error analytics data comprises providing a visualization of a trend in one or more error types over time.

Example 47 includes the subject matter of any of Examples 26-46, and wherein producing a visualization indicative of the error analytics data comprises providing one or more user interface elements to assign an error to designated personnel for remediation.

Example 48 includes the subject matter of any of Examples 26-47, and wherein producing a visualization indicative of the error analytics data comprises tracking a progress of remediation of errors.

Example 49 includes the subject matter of any of Examples 26-48, and wherein providing a visualization indicative of the error analytics comprises providing a knowledge base of solutions to errors.

Example 50 includes the subject matter of any of Examples 26-49, and wherein providing a visualization indicative of the error analytics comprises controlling access to the visualization based on user roles.

Example 51 includes one or more machine-readable storage media comprising a plurality of instructions stored thereon that, in response to being executed, cause a compute device to obtain error data indicative of errors resulting from integration of a component configured to add functionality to a data processing system of an institution; perform statistical analysis on the obtained error data to produce error analytics data; and produce a visual representation indicative of the error analytics data to enable efficient remediation of the errors.

Example 52 includes the subject matter of Example 51, and wherein to obtain error data pertaining to a subset of errors enrolled as rejects in an enrollment process.

Example 53 includes the subject matter of any of Examples 51 and 52, and wherein to obtain the error data comprises to obtain the error data from an event stream.

Example 54 includes the subject matter of any of Examples 51-53, and wherein to obtain the error data comprises to obtain error data indicative of one or more errors produced from a component that is new to the data processing system or that that has undergone a change in functionality.

Example 55 includes the subject matter of any of Examples 51-54, and wherein to obtain the error data comprises to obtain error data indicative of one or more errors produced from a component developed by a party other than an institution operating the data processing system.

Example 56 includes the subject matter of any of Examples 51-55, and wherein to obtain the error data comprises to obtain error data produced from a batch data ingestion process.

Example 57 includes the subject matter of any of Examples 51-56, and wherein to obtain the error data comprises to obtain error data produced from a file transfer process between the component and the data processing system.

Example 58 includes the subject matter of any of Examples 51-57, and wherein to obtain the error data comprises to obtain error data produced from a file reconciliation process associated with the integration.

Example 59 includes the subject matter of any of Examples 51-58, and wherein to obtain the error data comprises to obtain error data produced from a determination that a count of data items in a data file from the component does not match a count of records in a corresponding control file.

Example 60 includes the subject matter of any of Examples 51-59, and wherein to obtain the error data comprises to obtain error data produced from a publishing process associated with the integration.

Example 61 includes the subject matter of any of Examples 51-60, and wherein to obtain the error data comprises to obtain error data produced from transforming records in a file associated with the component to an object notation format.

Example 62 includes the subject matter of any of Examples 51-61, and wherein to obtain the error data comprises to obtain error data produced from a data update process associated with the integration.

Example 63 includes the subject matter of any of Examples 51-62, and wherein to obtain the error data comprises to obtain error data produced from one or more calls to an application programming interface associated with the data processing system to create or update data in a system database.

Example 64 includes the subject matter of any of Examples 51-63, and wherein to perform statistical analysis on the obtained error data comprises to determine the component that caused each error.

Example 65 includes the subject matter of any of Examples 51-64, and wherein to perform statistical analysis on the obtained error data comprises to determine a textual description of each error.

Example 66 includes the subject matter of any of Examples 51-65, and wherein to perform statistical analysis on the obtained error data comprises to determine a number of times that each type of error occurred within a predefined time frame.

Example 67 includes the subject matter of any of Examples 51-66, and wherein to determine the number of times that each type of error occurred within a predefined time frame comprises to determine the number for all time minus the present year, determine the number for the beginning of the present year to the present date, determine the number for the beginning of the present month to the present date, determine the number for the beginning of the present week to the present date, determine the number for the present date, or determine the number across all time.

Example 68 includes the subject matter of any of Examples 51-67, and wherein to perform statistical analysis on the obtained error data comprises to determine a trend in occurrences of each error over time.

Example 69 includes the subject matter of any of Examples 51-68, and wherein to perform statistical analysis on the obtained error data comprises to determine a percentage of each type of error in a total set of errors.

Example 70 includes the subject matter of any of Examples 51-69, and wherein to produce a visualization indicative of the error analytics data comprises to provide one or more user interface elements to filter the errors.

Example 71 includes the subject matter of any of Examples 51-70, and wherein to produce a visualization indicative of the error analytics data comprises to provide a visualization of a trend in one or more error types over time.

Example 72 includes the subject matter of any of Examples 51-71, and wherein to produce a visualization indicative of the error analytics data comprises to provide one or more user interface elements to assign an error to designated personnel for remediation.

Example 73 includes the subject matter of any of Examples 51-72, and wherein to produce a visualization indicative of the error analytics data comprises to track a progress of remediation of errors.

Example 74 includes the subject matter of any of Examples 51-73, and wherein to provide a visualization indicative of the error analytics comprises to provide a knowledge base of solutions to errors.

Example 75 includes the subject matter of any of Examples 51-74, and wherein to provide a visualization indicative of the error analytics comprises to control access to the visualization based on user roles.

1. A compute device comprising:
circuitry configured to:
obtain error data indicative of errors resulting from integration of a component configured to add functionality to a data processing system of an institution;
perform statistical analysis on the obtained error data to produce error analytics data; and
produce a visual representation indicative of the error analytics data to enable efficient remediation of the errors.

2. The compute device of claim 1, wherein to obtain the error data comprises to obtain error data pertaining to a subset of errors enrolled as rejects in an enrollment process.

3. The compute device of claim 1, wherein to obtain the error data comprises to obtain the error data from an event stream.

4. The compute device of claim 1, wherein to obtain the error data comprises to obtain error data indicative of one or more errors produced from a component that is new to the data processing system or that that has undergone a change in functionality.

5. The compute device of claim 1, wherein to obtain the error data comprises to obtain error data indicative of one or more errors produced from a component developed by a party other than an institution operating the data processing system.

6. The compute device of claim 1, wherein to obtain the error data comprises to obtain error data produced from a batch data ingestion process.

7. The compute device of claim 1, wherein to obtain the error data comprises to obtain error data produced from a file transfer process between the component and the data processing system.

8. The compute device of claim 1, wherein to obtain the error data comprises to obtain error data produced from a file reconciliation process associated with the integration.

9. The compute device of claim 8, wherein to obtain the error data comprises to obtain error data produced from a determination that a count of data items in a data file from the component does not match a count of records in a corresponding control file.

10. The compute device of claim 1, wherein to obtain the error data comprises to obtain error data produced from a publishing process associated with the integration.

11. The compute device of claim 10, wherein to obtain the error data comprises to obtain error data produced from transforming records in a file associated with the component to an object notation format.

12. The compute device of claim 1, wherein to obtain the error data comprises to obtain error data produced from a data update process associated with the integration.

13. The compute device of claim 12, wherein to obtain the error data comprises to obtain error data produced from one or more calls to an application programming interface associated with the data processing system to create or update data in a system database.

14. The compute device of claim 1, wherein to perform statistical analysis on the obtained error data comprises to determine the component that caused each error.

15. The compute device of claim 1, wherein to perform statistical analysis on the obtained error data comprises to determine a textual description of each error and determine a number of times that each type of error occurred within a predefined time frame.

16. The compute device of claim 15, wherein to determine the number of times that each type of error occurred within a predefined time frame comprises to determine the number for all time minus the present year, determine the number for the beginning of the present year to the present date, determine the number for the beginning of the present month to the present date, determine the number for the beginning of the present week to the present date, determine the number for the present date, or determine the number across all time.

17. The compute device of claim 1, wherein to perform statistical analysis on the obtained error data comprises to determine a trend in occurrences of each error over time and a percentage of each type of error in a total set of errors.

18. The compute device of claim 1, wherein to produce a visualization comprises to provide one or more user interface elements to filter the errors, provide a visualization of a trend in one or more error types over time, provide one or more user interface elements to assign an error to designated personnel for remediation, track a progress of remediation of errors, provide a knowledge base of solutions to errors, and control access to the visualization based on user roles.

19. A method comprising:
obtaining, by a compute device, error data indicative of errors resulting from integration of a component configured to add functionality to a data processing system of an institution;
performing, by the compute device, statistical analysis on the obtained error data to produce error analytics data; and
producing, by the compute device, a visual representation indicative of the error analytics data to enable efficient remediation of the errors.

20. One or more machine-readable storage media comprising a plurality of instructions stored thereon that, in response to being executed, cause a compute device to:
obtain error data indicative of errors resulting from integration of a component configured to add functionality to a data processing system of an institution;
perform statistical analysis on the obtained error data to produce error analytics data; and
produce a visual representation indicative of the error analytics data to enable efficient remediation of the errors.
